(19) United States
(12) Patent Application Publication
(10) Pub. No.: US 2006/0268479 A1
(43) Pub. Date: Nov. 30, 2006

(54) ESD protection structure

(75) Inventor: Werner Bischof, Besigheim (DE)

Correspondence Address: MCGRATH, GEISSLER, OLDS & RICHARDSON, PLLC, P.O. BOX 1364, FAIRFAX, VA, 22038-1364, US

(73) Assignee: ATMEL Germany GmbH

(21) Appl. No.: 11/443,247

(22) Filed: May 31, 2006

(30) Foreign Application Priority Data
Dec. 2, 2005 (DE) DE10 2005 057 614
May 31, 2005 (DE) DE10 2005 025 400

(51) Int. Cl. H02H 9/00

(52) U.S. Cl. 361/56

(57) ABSTRACT

An ESD protection structure for an electronic circuit arrangement, in particular for a HF power amplifier is provided. In the ESD protection structure, at least two semiconductor diodes are connected anti-serial to one another. Further, the pn junctions of the two semiconductor diodes possess a common zone of semiconductor material of a certain conductivity type. Thus, an ESD protection structure is provided that can be used even at relatively high frequencies, which offers a reliable protective effect in the event of overvoltages with improved modulation capability in the HF range without resulting in signal distortion during operation.

This nonprovisional application claims priority under 35 U.S.C. § 119(a) on German Patent Application Nos. DE 102005025400 and DE 102005057614, which were filed in Germany on May 31, 2005 and Dec. 2, 2005, respectively, and which are herein incorporated by reference.

### BACKGROUND OF THE INVENTION

1. Field of the Invention

The present invention relates to an ESD protection structure for an electronic circuit arrangement, in particular for a high frequency (HF) power amplifier, which can be connected between a reference voltage and a signal input of the circuit arrangement, having an electrical valve to limit a possible differential voltage between the signal input and the reference voltage, wherein the valve has at least one arrangement of two semiconductor diodes connected anti-serial to one another.

The invention also relates to a circuit arrangement for processing an electrical signal, in particular in the HF range, for example at 868 MHz in the ISM frequency band, having at least one first input for the signal to be processed; a second input for a reference voltage and a processing unit with a signal connection to at least the first input, wherein the processing unit is sensitive to voltage spikes of the signal.

2. Description of the Background Art

In the handling and use of electronic circuits, especially integrated circuits (IC), it is necessary to protect the components and assemblies contained therein from the effects of overvoltages and high currents associated therewith. In this context, overvoltages are defined as electrical signals such as those arising, for example, from a discharging of static charges, whether from persons or machine parts through an IC or from an IC through persons or machine parts. Such discharge processes are also called electrostatic discharge (ESD).

If signals of this nature, whose amplitude can be several kV, are fed to an integrated circuit, irreversible changes in its components or assemblies can occur, for example by burn-through of thin layers (thin-film burn-out), filamentation and short-circuiting of layer junctions (junction spiking), charge carrier injection in oxide layers (charge injection or oxide rupture), which under some circumstances leads to destruction of the entire IC.

In particular, HF inputs and open emitter connections of (bipolar) integrated HF power amplifiers, whose DC voltage is typically at 0 V, are sensitive to such ESD exposure. Therefore it is known, for example from DE 101 09 817, which is owned by the assignee of the present application, to connect two diode paths that are parallel to one another between the HF signal input and a reference voltage, wherein a plurality of diodes in a series arrangement can be provided in each path. In this context, the signal voltage periodically goes to negative values, wherein a maximum modulation of only Vₚᵢₙ=−0.7 V is possible with conventional ESD diodes. In this case, a steep rise in the current through the diodes takes place when the breakdown voltage is exceeded in a positive or negative direction. In this way, the ESD protection can lead to undesirable signal distortions at high HF power levels. The prior art series connection of multiple forward-biased diodes brings no improvement here, as the parasitic parallel substrate diodes that are present in the integrated design generally employed today will in any case become conducting with the aforementioned terminal voltage. In the following discussion, a “parasitic substrate diode” is understood to mean a semiconductor diode that is additionally and generally undesirably formed between a zone of a pn junction and a semiconductor substrate in which the aforementioned pn junction is formed.

An ESD protection structure of the generic type with only limited modulation capability is also known from U.S. Pat. No. 5,973,897. Furthermore, DE 36 35 523 A1, which corresponds to U.S. Pat. No. 4,829,344, discloses an ESD protection structure with two semiconductor diodes, not specified more exactly, that are connected anti-serial to one another and are arranged within or beneath a thick epitaxial layer. One side of one of the diodes here is permanently connected to ground or the substrate, resulting in a limited usability of the proposed ESD protection circuit.

### SUMMARY OF THE INVENTION

It is therefore an object of the present invention to provide an ESD protection circuit and a circuit arrangement using the former, which offer a reliable protective effect with improved modulation capability in the HF range without resulting in signal distortion during operation, wherein the proposed ESD protection circuit must also be simple and flexible to use in its circuit design.

The object is attained by an ESD protection structure of the aforementioned type in that the pn junctions of the two semiconductor diodes possess a common zone of semiconductor material of a first conductivity type, and in that the other zone of each pn junction of the two semiconductor diodes is freely connectable. This achieves, in particular, a significant increase (in terms of amount) in the breakdown voltage, which has a positive effect on the modulation capacity of a subsequent circuit and on the available signal quality. Moreover, due to the reduced surface dimensions as compared to conventional diodes, the special design of the diode structure with common zone that is employed in accordance with the invention contributes to a reduction in parasitic capacitance to the substrate, so that the diode structure is suitable for higher frequencies.

In addition, the object is attained through a circuit arrangement of the aforementioned type in which an ESD protection structure is provided.

In this context, according to an embodiment of the invention, the semiconductor diodes can be, for example, Zener diodes. In this way, according to the invention the (negative) breakdown voltage can be displaced to a value Vₘᵢₙ≈−7 V, with the result that no distortion of the signal occurs, even at high HF power.

Moreover, provision can be made according to the invention for the arrangement of the semiconductor diodes to be symmetrical. This can preferably be accomplished in that each diode has, for example, one identically-sized semiconductor region of a second conductivity type that is “its own,” e.g. an anode of a p-doped semiconductor material, while a (middle) region of the first conductivity type, here for example in the form of a cathode of an n-doped semiconductor material, is common to both diodes. This achieves the result that the parasitic capacitance to the substrate of the arrangement thus created is cut approximately in half relative to a corresponding arrangement of conventional diodes.

The common zone here can be designed as a buried layer in a surrounding semiconductor substrate, in particular of the second conductivity type.

As a result, the ESD protection structure thus created is, as already explained, also suitable for use with signals at higher frequencies.

A further embodiment of the present invention provides an isolating zone to electrically isolate the other zones of the pn junction from one another and from the semiconductor substrate, in particular by providing a trench filled with an appropriate oxide, a field oxide, or a suitable separating implantation. In order to keep the complexity of construction of the ESD protection structure thus created as small as possible, further provision can be made for the isolating zone to be made thin in comparison with a vertical overall dimension of the ESD protection structure, i.e. in comparison to its depth, thus resulting, in particular, in corresponding size and cost advantages over prior art protective structures having thick epitaxial layers.

An inventive circuit arrangement can also be distinguished in that the processing unit is designed as an amplifier, in particular as a HF power amplifier.

In this context, at least the processing unit of the circuit arrangement are designed as an integrated circuit. In an especially preferred embodiment, however, both the ESD protection circuit and the processing unit are designed in common as an integrated circuit.

Such a circuit arrangement benefits in a corresponding manner from all the aforementioned advantages of the inventive ESD protection structure, such as modulation capacity, signal quality, and the spectral range of application.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a block diagram of a circuit arrangement with an ESD protection structure according to an embodiment of the present invnetion;

FIG. 2 is a circuit diagram of the ESD protection structure according to FIG. 1; and

FIG. 3 is a cross-section through a symmetrical ESD structure according to an embodiment of the present invention.

### DETAILED DESCRIPTION

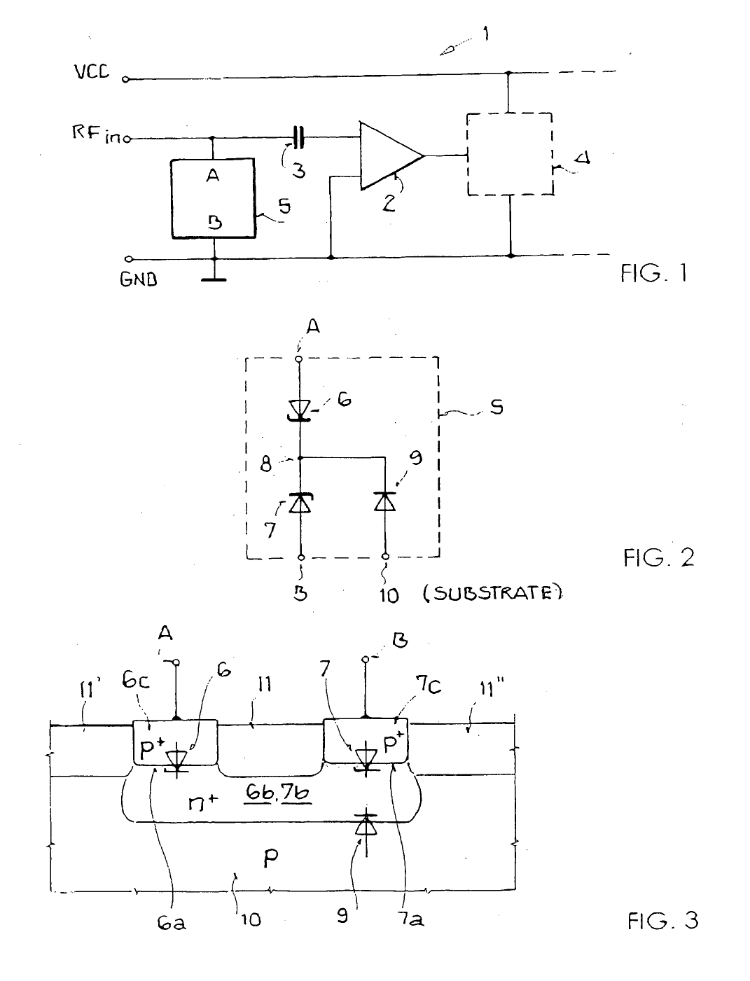

FIG. 1 shows a block diagram of a circuit arrangement 1 for processing an electrical signal, in particular in the high frequency range (HF range), for example at 868 MHz. The circuit arrangement 1 includes a first input RFᵢₙ for the signal to be processed, and also a second input GND for a reference voltage, preferably ground. In addition, the circuit arrangement 1 has a processing unit 2 for processing the electrical signal; according to the embodiment depicted, the processing unit can be a bipolar amplifier for RF signals in the HF range. This amplifier has a signal connection to at least the first input RFᵢₙ, whereby the amplifier shown in FIG. 1 is additionally connected on an input side to a capacitor 3 in the manner of a high pass filter, resulting in what is called an active filter circuit.

Following the processing unit 2, the circuit arrangement 1 can includes additional circuit components 4, not described here in detail (shown in dashed lines in FIG. 1), which further process the signals RFᵢₙ (pre-) processed by the processing unit 2. In the embodiment shown, an additional input V_{CC} for a supply voltage is provided to supply energy to both the processing unit 2 and, if applicable, the additional circuit components 4.

Since the processing unit 2, for example, the base-emitter path of a bipolar transistor contained therein, are generally sensitive to voltage spikes of the HF signal and the high discharge currents associated therewith, the circuit arrangement 1 also has an ESD protection structure 5 for dissipating voltage spikes, which is connected between the reference voltage GND and the signal input RFᵢₙ of the circuit arrangement, and which has an electrical valve to limit a possible differential voltage between the signal input and the reference voltage, whereby the valve has at least one arrangement of semiconductor diodes, which is described in detail below with reference to FIGS. 2 and 3.

In FIG. 1, the freely connectable nodes connecting the ESD protection structure 5 to the remainder of the circuit arrangement 1 are labeled A, B. This labeling is also preserved in the subsequent FIGS. 2 and 3 to represent the circuit relationships.

FIG. 2 shows a basic schematic of an inventive ESD protection structure 5, such as is preferably used in the circuit arrangement 1 shown in FIG. 1. Between the connection points/nodes A, B (see also FIG. 1) which are freely connectable according to the invention, i.e. between the inputs RFᵢₙ and GND, the ESD protection structure 5 has a valve in the form of an arrangement of semiconductor diodes 6, 7, which are specially designed as Zener diodes and are connected anti-serial to one another so that the cathodes of the diodes 6, 7 are connected through a common central node 8. FIG. 2 also shows a parasitic substrate diode 9 (see also FIG. 3), which is generally produced when the diodes 6, 7 are designed in integrated form as pn junctions in a semiconductor substrate 10 (see also FIG. 3).

On account of the anti-serial diode arrangement, the ESD protection structure according to FIG. 2 permits modulation of the processing unit 2 (FIG. 1) to a (minimum) voltage Vₘᵢₙ≈−7 V, so that no signal distortion takes place, even at high HF power levels—although such distortion would have taken place in a conventional protection structure without the diode 6, since the substrate diode 9 becomes conductive at a much lower voltage level (typically V≈−0.7 V) regardless of the design of the diode 7.

However, the arrangement shown as a circuit schematic in FIG. 2 does have the disadvantage—if standard diodes 6, 7 are used—that parasitics to the semiconductor substrate, in particular parasitic capacitances, become very large and thus adversely affect the properties of the ESD protection structure 5, and/or the overall circuit arrangement 1, especially with respect to its suitability for HF applications.

This is why the present invention provides, as shown in FIG. 3, for the pn junctions 6a, 7a of the two semiconductor diodes 6, 7 (Zener diodes) to have a common zone 6b, 7b (cathode) of semiconductor material of a first conductivity type. According to the exemplary embodiment shown, the common zone 6b, 7b is an n⁺-doped semiconductor material (in the form of an n⁺-subcollector), preferably n⁺-silicon. Accordingly, the other zone 6c, 7c (anode) of the pn junctions 6a, 7a is made of a second, p⁺-doped semiconductor material and is freely connectable through the externally located connection nodes A, B (see FIG. 1, 2). The aforementioned zones 6b, 6c, 7b, 7c are embedded in the semiconductor substrate 10 as an arrangement with an overall design that is essentially U-shaped in cross-section, which, in particular, is a p-doped substrate. In accordance with the remarks relating to FIG. 2, therefore, a substrate diode 9 formed between the cathode 6b, 7b and the substrate 10 is again shown by way of example in FIG. 3.

The region between the sides of the aforementioned U-shaped zone arrangement is designed as an isolating zone 11 for electrically isolating the anodes 6c, 7c through a trench filled with an appropriate oxide, a field oxide, or a suitable separating implantation, so that fields may be efficiently dissipated in this region. The isolating zone 11 continues on both sides of the described diode arrangement 6, 7, so that no additional parasitics can arise in the outer edge regions 11′, 11″ around the diode arrangement. The isolating zone 11, 11′, 11″ is designed to be relatively thin in comparison with a vertical overall dimension of the inventive ESD protection structure 5.

The common cathode 6b, 7b of the anti-serial diodes 6, 7 is designed as a common buried layer, in order in this way to reduce parasitic effects, in particular such as capacitances to the substrate 10, as efficiently as possible. In this way, the embodiment from FIG. 3 makes it possible to cut in half the parasitic capacitance to the substrate, which would otherwise make the ESD protection structure 5 shown (FIG. 1, 2) unsuitable for high frequencies.

The quantitative design of the respective dopings of the zones 6b, 6c, 7b, 7c shown in FIG. 3 and their dimensions are within the scope of technical knowledge of practitioners of the art. Moreover, all of the dopings can, in principle, also be reversed (n⇄p) with regard to the respective conductivity type, something which is also familiar to those of average skill in the art.

The design shown in FIG. 3 of the diode arrangement 6, 7 of the ESD protection structure 5 is also called “symmetrical,” which is immediately obvious from said drawing. This is achieved in that each diode 6, 7 has “its own” anode region 6c, 7c of a certain conductivity type, here p⁺-doped, while a (middle) region 6b, 7b of the other conductivity type, here n⁺-doped, is associated with both diodes 6, 7 in common as a cathode, so that in accordance with the invention the node 8 included in FIG. 2 is located in or is (partly) formed by the cathode layer 6b, 7b. Accordingly, in the example embodiment shown, the anodes 6c, 7c are also identically designed with respect to their dimensions, so that an ESD protection structure results according to the invention with improved electrical characteristics—in particular for HF applications.

Moreover, because of the free connectability, in particular of the externally located connection nodes A, B according to FIG. 3, the inventive ESD protection structure is especially versatile in its applicability in terms of circuit design.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An ESD protection structure for an electronic circuit arrangement, the ESD protection structure being connected between a reference voltage and a signal input of the circuit arrangement, the ESD protection structure comprising:
an electrical valve for limiting a differential voltage between the signal input and the reference voltage, the electrical valve including two semiconductor diodes being connected anti-serial to one another,
wherein pn junctions of the two semiconductor diodes have a common zone of semiconductor material of a first conductivity type, and
wherein a second zone of each pn junction of the two semiconductor diodes is freely connectable.

2. The ESD protection structure according to claim 1, wherein the common zone is a buried layer in a semiconductor substrate.

3. The ESD protection structure according to claim 1, wherein the semiconductor diodes are arranged substantially symmetrical.

4. The ESD protection structure according to claim 1, wherein the semiconductor diodes are Zener diodes.

5. The ESD protection structure according to claim 1, wherein an isolating zone is provided to electrically isolate the second zones of the pn junctions from one another and from a semiconductor substrate by providing a trench filled with an appropriate oxide, a field oxide, or a suitable separating implantation.

6. The ESD protection structure according to claim 5, wherein the isolating zone is formed to be thinner than a vertical dimension of the ESD protection structure.

7. A circuit arrangement for processing an electrical signal, the circuit arrangement comprising:
at least one first input for the electrical signal to be processed;
a second input for a reference voltage;
a processing unit having a signal connection to at least the first input, the processing unit being sensitive to voltage spikes; and
an ESD protection structure being connected between the first and the second inputs, the ESD protection structure comprising:
an electrical valve for limiting a differential voltage between the signal input and the reference voltage, the electrical valve including two semiconductor diodes being connected anti-serial to one another,
wherein pn junctions of the two semiconductor diodes have a common zone of semiconductor material of a first conductivity type, and
wherein a second zone of each pn junction of the two semiconductor diodes is freely connectable.

8. The circuit arrangement according to claim 7, wherein the processing unit is an amplifier or a HF power amplifier.

9. The circuit arrangement according to claim 7, wherein at least the processing unit is an integrated circuit.

10. The circuit arrangement according to claim 7, wherein both the ESD protection structure and the processing unit are designed in common as an integrated circuit.

11. The ESD protection structure according to claim 1, wherein the electronic circuit arrangement is a HF power amplifier.

12. The ESD protection structure according to claim 5, wherein the isolating zone is a trench filled with an oxide, a field oxide, or a separating implantation.

13. The circuit arrangement according to claim 7, wherein the electrical signal is a HF signal.
